(19) United States
(12) Patent Application Publication
(10) Pub. No.: US 2006/0112129 A1
(43) Pub. Date: May 25, 2006

(54) Attributed relationship modeling with perspective

(75) Inventors: Michael S. Kostojohn, Seattle, WA (US); Patrick M. Dengler, Redmond, WA (US); Srinivasa R. Burugapalli, Sammamish, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 10/997,526

(22) Filed: Nov. 24, 2004

(51) Int. Cl. G06F 7/00

(52) U.S. Cl. 707/102

(57) ABSTRACT

A method of describing in a computer an entity is disclosed. The method may have the steps of storing data related to the entity, allowing a relationship to be assigned to the entity, assigning attributes to the relationship, assigning a perspective to the relationship wherein the perspective filters the attributes of the relationship, allowing a user to select the desired perspective of the relationship and allowing a user to view the data related to the entity based on the perspective selected.

### BACKGROUND

Entity modeling systems attempt to assist users track information about entities where the entity can be a person, a business or any other group of interest. Often, these systems have multiple entries for the entities which are entered by different people. The person entering the data often enters data that is of interest to him/her. As a result, multiple entries of the same individual or business may be created. In addition, traditional models do not allow a relationship to be viewed from a variety of perspectives which may result in important information not being discovered.

### SUMMARY

A method of describing in a computer an entity is disclosed. The method may have the steps of storing data related to the entity, allowing a relationship to be assigned to the entity, assigning attributes to the relationship, assigning a perspective to the relationship wherein the perspective filters the attributes of the relationship, allowing a user to select the desired perspective of the relationship and allowing a user to view the data related to the entity based on the perspective selected. The entities may be one of organizational types and individual types, and the organization types may be one of businesses, government agencies, associations, and households. The relationships to organizations may be vendor relationships, partner relationships, competitor relationships, customer relationships, prospect relationships and member relationship and the relationships to individuals may be customer relationships, prospect relationships, vendor relationships, member relationships and employment relationships. Individual types may be contacts and relationships to individuals may be customer relationships, prospect relationships, vendor relationships, member relationships, employment relationships, friends, relatives, spouse, mentor and influences. The method also allows for the creation of schema that reflects the method and wherein the schema are extensible. The schema may be adapted for specific industries and specific locations. A computing apparatus and a computer readable medium that are programmed in accordance with the method also are disclosed.

### DRAWINGS

FIG. 1 is a block diagram of a computing system that may operate in accordance with the claims;

FIG. 2 is a flowchart of an embodiment of a method of modeling an entity in accordance with the claims; and

FIG. 3 is a graphical illustration of the information that may be available by using the method or modeling an entity in accordance with the claims.

### DESCRIPTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

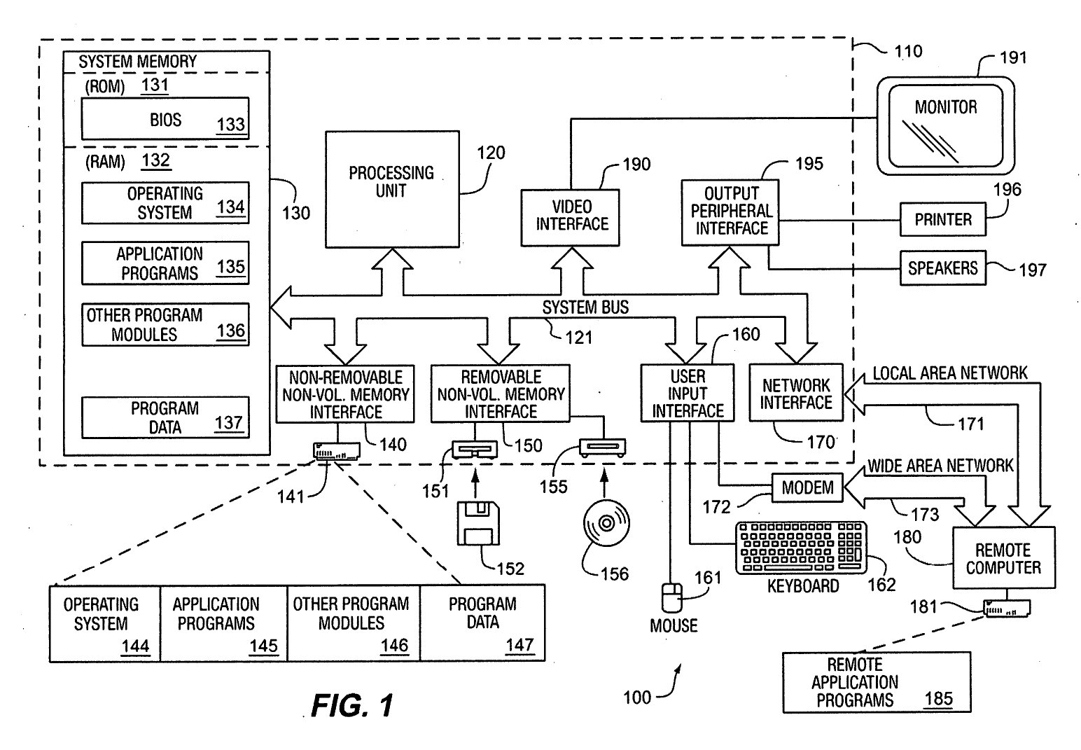

FIG. 1 illustrates an example of a suitable computing system environment 100 on which a system for the steps of the claimed method and apparatus may be implemented. The computing system environment 100 is only one example of a suitable computing environment and is not intended to suggest any limitation as to the scope of use or functionality of the claims. Neither should the computing environment 100 be interpreted as having any dependency or requirement relating to any one or combination of components illustrated in the exemplary operating environment 100.

The steps of the claimed method and apparatus are operational with numerous other general purpose or special purpose computing system environments or configurations. Examples of well known computing systems, environments, and/or configurations that may be suitable for use with the claims include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The steps of the claimed method and apparatus may be described in the general context of computer-executable instructions, such as program modules, being executed by a computer. Generally, program modules include routines, programs, objects, components, data structures, etc. that perform particular tasks or implement particular abstract data types. The claims may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the steps of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless, media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Relationships of Entities

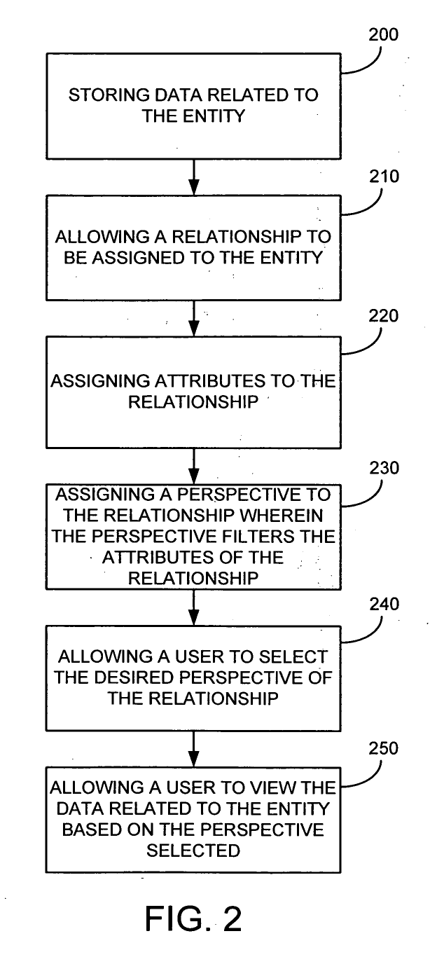

FIG. 2 illustrates a method of describing in a computer, an entity. At block 200, data related to an entity may be stored. An entity may be a business, a government agency, association, a household, a vendor, a partner, a competitor, a prospect, a member of a group, an individual—virtually any person or group about which relevant data is desired to be stored in a way in which it can be retrieved. The data that can be stored related to an entity is almost limitless, but may have a relationship to desired information. For example, the most common information that would be stored for an entity would be the entity's address, telephone number, email address, and any other information that most users would desire to know and that would be common to most users. In general, most entities will either be organizational types or individual types, where organizational types may include businesses, government agencies, associations and households, and where individual types may include contacts.

At block 210, a relationship may be assigned to the entity. If the entity is an organization, the relationships may include vendor relationships, partner relationships, competitor relationships, customer relationships, prospect relationships and member relationships. If the entity is an individual, the relationships may include customer relationships, prospect relationships, vendor relationships, member relationships, employment relationships, friend relationships, relative relationships, spouse relationships, mentor relationships and influencer relationships. An entity may have more than one relationship. For example, Alpha Corporation may be a partner with Beta Corporation on certain projects but may be a competitor on other projects.

At block 230, a perspective to the relationship may be assigned where the perspective filters the attributes of the relationship. In one example, assuming the relationship is a vendor, the vendor and the buyer may have a two way relationship, where the vendor not only sells things to the buyer, but the vendor also buys things from the purchaser. By assigning a perspective to the relationship, data can be filtered, for example, if an entity has a two way relationship with a second entity, certain information may be useful to see from the buyer's perspective and other information may be useful to see from a seller's perspective.

At block 240, a user may select the desired perspective of the relationship. As described previously, relationships often have many facets and by selecting a perspective, different facets of the relationship can be examined and the related data can be displayed. For example, Alpha Corp. may purchase materials from Beta Corp., creating a vendor relationship. In addition, Beta Corp. may purchase materials from Alpha Corp., creating a customer relationship. The relationship can be viewed from either perspective, or even more perspectives, if more perspectives are present. The perspective selected may be used to filter the data. For example, looking at Beta Corp. from a buyer's perspective may bring up relevant buying price data, contact data, etc., while viewing data from a seller's perspective may bring up past order status, salesmen assigned to the client, data of last sale, items sold, etc., but it may not display buying price data because such information would be filtered out as being irrelevant to the seller's perspective.

At block 250, a user may be permitted to view the data related to the entity based on the perspective selected. For example, if the perspective of a buyer is selected, a user may view the price that a vendor charges for a certain item, or an expected delivery time for an item, or the past history of delivery from the vendor. However, the user also has the option to select to view the relationship from the perspective of the seller. Information from the seller's perspective may indicate that the buyer has been slow on paying in the past or has complaints about the quality of products sold. Both these perspectives may be useful to the user in negotiating price or gaining competitive advantage.

In addition, the method allows for creation of schema that reflects the above-described method where the schema are extensible and can be adapted for specific industries. For example, the attributes in relationships in the sporting good industry would be different than the attributes to be stored in the chemical industry. The schema can be adapted for specific locations. For example, if a location is in the city of Chicago, it may be useful to store what is the closest public transportation stop to a particular location.

By implementing a method, data can be centrally stored in one single database, but can be viewed by a variety of users from a variety of perspectives. For example, if a particular organization purchases from a conglomerate, numerous products may be purchased from this conglomerate and numerous users may each have different contacts within the conglomerate. By storing the information in one single, central location and being able to evaluate the relationship from a variety of perspectives, the multiple buyers from the conglomerate may realize their combined buying power is stronger than they previously realized and additional discounts may be obtainable.

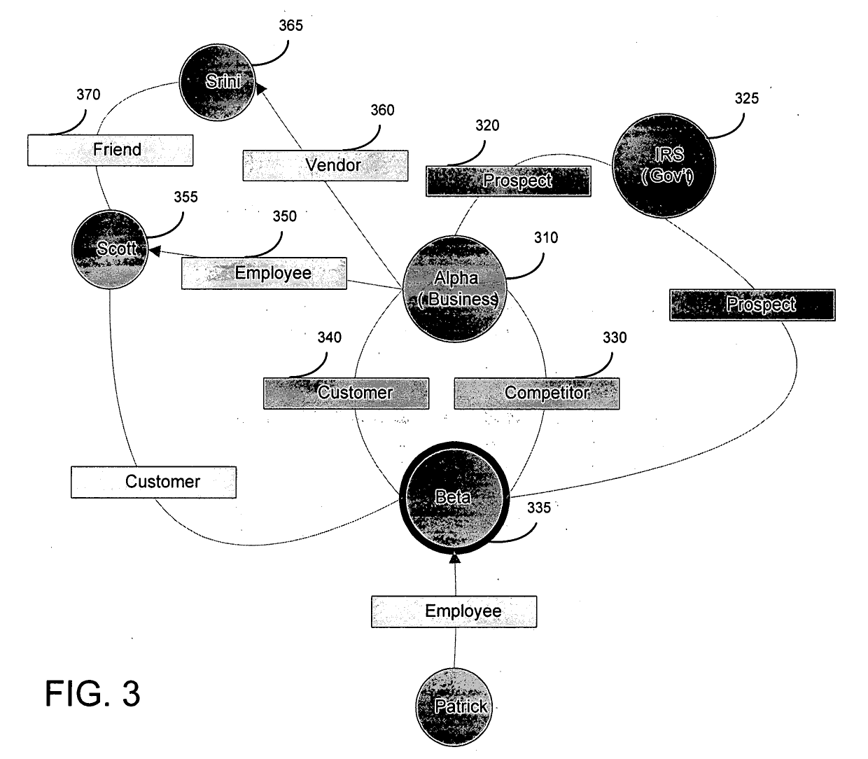

As a further example, FIG. 3 illustrates a graphical depiction of the type of information that may be available when viewing relationships. Alpha Corp. 310 has numerous relationships. Specifically, Alpha 310 may have a prospect relationship 320 with the IRS 325, may have a competitor relationship 330 with Beta 335, may have a customer relationship 340 with Beta 335, may have an employee relationship 350 with Scott 355, and may have a vendor relationship 360 with Srini 365. By selecting to view the employee relationship 350 between Alpha 310 and Scott 355 from Alpha's 310 perspective, the system may display the friend relationship 370 between Scott 355 and Srini 365 which Alpha 310 may be able to utilize to obtain a better vendor relationship 360 between Alpha 310 and Srini 365. By being able to view the relationship between Scott 355 and Alpha 310, the friend relationship 370 between Scott 355 and Srini 365 may be uncovered. By examining the relationship, additional detail beyond the individuals may be seen.

By storing information by relationship, data storage and organization may be improved. For example, instead of having multiple versions of Srini 365 stored, each with different information depending on who entered the information, a single version of Srini 365 may be stored, which may reduce needed storage space. In addition, by viewing relationships, users can view Srini's 365 relationships from different perspectives and each new perspective may reveal additional information that may not have been available if multiple versions of Srini 365 were saved. Instead of having to gather information in a haphazard manner, a user can simply select drop-down boxes to view additional information that otherwise would not be accessible or the meaning of the information may have been lost.

Although the forgoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

1-30. (canceled)

31. A method of describing in a computer an entity comprising the steps of:
storing data related to the entity;
allowing a relationship to be assigned to the entity;
assigning attributes to the relationship; and
assigning a perspective to the relationship wherein the perspective filters the attributes of the relationship.

32. The method of claim 31, wherein entities comprise organizational types and individual types.

33. The method of claim 32, wherein organization types comprise businesses, government agencies, associations, and households.

34. The method of claim 33, wherein relationships to organizations comprise vendor relationships, partner relationships; competitor relationships; customer relationships; prospect relationships and member relationships.

35. The method of claim 33, wherein relationships to individuals comprise customer relationships, prospect relationships, vendor relationships, member relationships and employment relationships.

36. The method of claim 32, wherein individual types comprise contacts.

37. The method of claim 36, wherein relationships to individuals comprise customer relationships; prospect relationships; vendor relationships, member relationships, employment relationships, friends, relatives, spouse, mentor, influences.

38. The method of claim 31, wherein the method allows for the creation of schema that reflects the method and wherein the schema are extensible.

39. The method of claim 38, wherein the schema are adapted for specific industries.

40. The method of claim 38, wherein the schema are adapted for specific locations.

41. The method of claim 31, further comprising allowing a user to select the desired perspective of the relationship.

42. The method of claim 31, further comprising allowing a user to view the data related to the entity based on the perspective selected.

43. A computer readable medium having computer executable instructions for performing steps of describing an entity comprising:
(a) storing data related to the entity;
(b) allowing a relationship to be assigned to the entity;
(c) assigning attributes to the relationship; and
(d) assigning a perspective to the relationship wherein the perspective filters the attributes of the relationship.

44. The computer readable medium of claim 43, wherein entities comprise organizational types and individual types.

45. The computer readable medium of claim 43, wherein organization types comprise businesses, government agencies, associations, and households.

46. The computer readable medium of claim 45, wherein relationships to organizations comprise vendor relationships, partner relationships; competitor relationships; customer relationships; prospect relationships and member relationships.

47. The computer readable medium of claim 45, wherein relationships to individuals comprise customer relationships, prospect relationships, vendor relationships, member relationships and employment relationships.

48. The computer readable medium of claim 44, wherein individual types comprise contacts.

49. The computer readable medium of claim 48, wherein relationships to individuals comprise customer relationships; prospect relationships; vendor relationships, member relationships, employment relationships, friends, relatives, spouse, mentor, influences.

50. The computer readable medium of claim 43, wherein the method allows for the creation of schema that reflects the method and wherein the schema are extensible.

51. The computer readable medium of claim 50, wherein the schema are adapted for specific industries.

52. The computer readable medium of claim 50, wherein the schema are adapted for specific locations.

53. The computer readable medium of claim 45, having further computer executable instructions comprising allowing a user to select the desired perspective of the relationship.

54. The computer readable medium of claim 45, having further computer executable instructions comprising allowing a user to view the data related to the entity based on the perspective.

55. A computing apparatus, comprising:
a display unit that is capable of generating video images;
an input device;
a processing apparatus operatively coupled to said display unit and said input device, said processing apparatus comprising a processor and a memory operatively coupled to said processor,
a network interface connected to a network and to the processing apparatus;
said processing apparatus being programmed to store data related to the entity;
said processing apparatus being programmed to allow a relationship to be assigned to the entity;
said processing apparatus being programmed to assign attributes to the relationship; and
said processing apparatus being programmed to assign a perspective to the relationship wherein the perspective filters the attributes of the relationship.

56. The computing apparatus of claim 55, wherein entities comprise organizational types and individual types.

57. The computing apparatus of claim 56, wherein organization types comprise businesses, government agencies, associations, and households.

58. The computing apparatus of claim 57, wherein relationships to organizations comprise vendor relationships, partner relationships; competitor relationships; customer relationships; prospect relationships and member relationships.

59. The computing apparatus of claim 57, wherein relationships to individuals comprise customer relationships, prospect relationships, vendor relationships, member relationships and employment relationships.

60. The computing apparatus of claim 56, wherein individual types comprise contacts.

61. The computing apparatus of claim 60, wherein relationships to individuals comprise customer relationships; prospect relationships; vendor relationships, member relationships, employment relationships, friends, relatives, spouse, mentor, influences.

62. The computing apparatus of claim 55, wherein the method allows for the creation of schema that reflects the method and wherein the schema are extensible.

63. The computing apparatus of claim 62, wherein the schema are adapted for specific industries.

64. The computing apparatus of claim 62, wherein the schema are adapted for specific locations.

65. The computing apparatus of claim 55, said processing apparatus being programmed to allow a user to select the desired perspective of the relationship.

66. The computing apparatus of claim 55, said processing apparatus being programmed to allow a user to view the data related to the entity based on the perspective selected.
